(19) United States
(12) Patent Application Publication
(10) Pub. No.: US 2026/0339706 A1
(43) Pub. Date: Oct. 29, 2026

(54) DATA PROCESSING METHOD, APPARATUS, ELECTRONIC DEVICE, STORAGE MEDIUM, AND PROGRAM PRODUCT

(71) Applicant: Beijing Zitiao Network Technology Co., Ltd., Beijing (CN)

(72) Inventors: Ao YU, Beijing (CN); Junsheng WU, Beijing (CN); Huajian YU, Beijing (CN); Bo REN, Beijing (CN); Mingzhen ZHANG, Beijing (CN)

(21) Appl. No.: 19/661,430

(22) Filed: Apr. 28, 2026

(30) Foreign Application Priority Data
Apr. 28, 2025 (CN) 202510550154.6

(51) Int. Cl. G06F 9/48; G06F 9/451

(52) U.S. Cl. CPC G06F 9/4881; G06F 9/451

(57) ABSTRACT

Embodiments of the present disclosure provide a data processing method and apparatus, an electronic device, a storage medium, and a program product. The method includes: displaying a task editing page in a browser of a first end in response to a task editing request; receiving, through the task editing page, a node editing operation for at least one graphical node, and obtaining a data processing task according to the node editing operation, where at least part of data processing operations in data processing logic corresponding to the graphical node are executed at a second end; and receiving an execution trigger operation for the data processing task and executing the data processing task according to the execution trigger operation to obtain execution result data of the data processing task.

### CROSS-REFERENCE TO RELATED APPLICATIONS

This application claims priority to Chinese Application No. 202510550154.6 filed Apr. 28, 2025, the disclosure of which is incorporated herein by reference in its entirety.

### FIELD

Embodiments of the present disclosure relate to the field of computer processing technologies and, in particular, to a data processing method, an apparatus, an electronic device, a storage medium, and a program product.

### BACKGROUND

In a pluralistic scenario of information exchange, data processing has become an indispensable part. Since information exchange scenarios are highly diverse, requirements for data processing in different scenarios also vary greatly. Even for a certain piece of data, its data processing requirements often differ in different scenarios.

### SUMMARY

The present disclosure provides a data processing method, an apparatus, an electronic device, a storage medium, and a program product to enable data to be processed more intuitively, flexibly, and conveniently by combining data processing resources at multiple ends, thereby reducing the difficulty in data processing and improving the efficiency of editing data processing tasks.

According to a first aspect, an embodiment of the present disclosure provides a data processing method. The method includes: displaying a task editing page in a browser of a first end in response to a task editing request; receiving, through the task editing page, a node editing operation for at least one graphical node, and obtaining a data processing task according to the node editing operation, where at least part of data processing operations in data processing logic corresponding to the graphical node are executed at a second end; and receiving an execution trigger operation for the data processing task and executing the data processing task according to the execution trigger operation to obtain execution result data of the data processing task.

According to a second aspect, an embodiment of the present disclosure further provides a data processing apparatus. The apparatus includes: a page display module configured to display a task editing page in a browser of a first end in response to a task editing request; a task obtaining module configured to receive, through the task editing page, a node editing operation for at least one graphical node, and obtain a data processing task according to the node editing operation, where at least part of data processing operations in data processing logic corresponding to the graphical node are executed at a second end; and

a task execution module configured to receive an execution trigger operation for the data processing task and execute the data processing task according to the execution trigger operation to obtain execution result data of the data processing task.

According to a third aspect, an embodiment of the present disclosure further provides an electronic device. The electronic device includes: one or more processors; and a storage apparatus configured to store one or more programs, where the one or more programs, when executed by the one or more processors, cause the one or more processors to implement the data processing method according to any one of the embodiments of the present disclosure.

According to a fourth aspect, an embodiment of the present disclosure further provides a storage medium including computer-executable instructions that, when executed by a computer processor, are configured to perform the data processing method according to any one of the embodiments of the present disclosure.

According to a fifth aspect, an embodiment of the present disclosure further provides a computer program product including a computer program that, when executed by a processor, implements the data processing method according to any one of the embodiments of the present disclosure.

### BRIEF DESCRIPTION OF THE DRAWINGS

The foregoing and other features, advantages, and aspects of the embodiments of the present disclosure become more apparent with reference to the following specific implementations and in conjunction with the drawings. Throughout the drawings, the same or similar reference numerals denote the same or similar elements. It should be understood that the drawings are schematic and that parts and elements are not necessarily drawn to scale.

FIG. 1 is a schematic flowchart of a data processing method according to an embodiment of the present disclosure;

FIG. 2 is an example diagram of processing of a sub-processing task applicable to a data processing method according to an embodiment of the present disclosure;

FIG. 3 is a schematic flowchart of another data processing method according to an embodiment of the present disclosure;

FIG. 4A is an example diagram of a data processing task including a plurality of graphical nodes according to an embodiment of the present disclosure;

FIG. 4B is an example diagram of a dependency table according to an embodiment of the present disclosure;

FIG. 4C is an example diagram of a reverse dependency table according to an embodiment of the present disclosure;

FIG. 5 is a schematic flowchart of another data processing method according to an embodiment of the present disclosure;

FIG. 6 is a schematic flowchart of another data processing method according to an embodiment of the present disclosure;

FIG. 7 is a schematic flowchart of an optional example of a data processing method according to an embodiment of the present disclosure;

FIG. 8 is a schematic diagram of a structure of a data processing apparatus according to an embodiment of the present disclosure; and

FIG. 9 is a schematic diagram of a structure of an electronic device for implementing an embodiment of the present disclosure according to an embodiment of the present disclosure.

### DETAILED DESCRIPTION OF EMBODIMENTS

The embodiments of the present disclosure are described in more detail below with reference to the drawings. The drawings illustrate some embodiments of the present disclosure, but it should be understood that the present disclosure may be implemented in various forms and should not be construed as being limited to the embodiments set forth herein. Instead, these embodiments are provided for more thorough and complete understanding of the present disclosure. It should be understood that the drawings and embodiments of the present disclosure are only for illustrative purposes and are not intended to limit the scope of protection of the present disclosure.

It should be understood that steps described in method implementations of the present disclosure may be performed in different orders and/or in parallel. Furthermore, the method implementations may include additional steps and/or omit the steps shown. The scope of the present disclosure is not limited in this respect.

As used herein, the term "include/comprise" and variations thereof are open-ended inclusions, that is, "include/comprise but not limited to". The term "based on" is "at least partially based on". The term "an embodiment" means "at least one embodiment". The term "another embodiment" means "at least one another embodiment". The term "some embodiments" means "at least some embodiments". Related definitions of other terms will be given in the description below.

It should be noted that concepts such as "first" and "second" mentioned in the present disclosure are only used to distinguish between different apparatuses, modules, or units and are not used to limit the order or interdependence of functions performed by these apparatuses, modules, or units.

It should be noted that modifications of "one" and "a plurality of" mentioned in the present disclosure are illustrative rather than restrictive. Those skilled in the art should understand that "one" or "a plurality of" should be understood as "one or more" unless otherwise clearly indicated in the context.

The names of messages or information exchanged between a plurality of apparatuses in the implementations of the present disclosure are only for illustrative purposes and are not intended to limit the scope of these messages or information.

It may be understood that before the use of the technical solutions disclosed in the embodiments of the present disclosure, users should be informed of the type, range of use, use scenarios, etc., of personal information involved in the present disclosure and the authorization of the users should be obtained in an appropriate manner in accordance with relevant laws and regulations.

For example, in response to receiving an active request from a user, prompt information is sent to the user to clearly inform the user that the requested operation will require access to and use of the user's personal information. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to choose whether to "agree" or "disagree" to provide the personal information to the electronic device.

It should be understood that the above process of notifying the user and acquiring user authorization is only illustrative and does not limit the implementations of the present disclosure. Other manners that satisfy relevant laws and regulations may also be applied in the implementations of the present disclosure.

It should be understood that the data involved in the technical solution (including but not limited to the data itself, acquisition or use of the data) should comply with requirements of corresponding laws, regulations, and related provisions.

To meet differentiated data processing requirements, in a related technology, customized program data usually needs to be written separately for each data processing requirement. However, developing customized program data not only requires developers to have a solid programming foundation and business understanding capability, but also requires them to write a large amount of underlying implementation details and logic verification. The development process is complex and time-consuming, resulting in low efficiency in editing data processing tasks.

According to the technical solution of the embodiments of the present disclosure, a task editing page is displayed in a browser of a first end in response to a task editing request so that the task editing page is displayed through the browser without installing specific software to edit a task, and a visual presentation of task editing may be realized to provide an interactive interface for task editing operations. Then, a node editing operation for at least one graphical node is received through the task editing page and a data processing task is determined according to the node editing operation so that the difficulty in editing the data processing task is reduced and flexible editing of an output processing task may be realized to meet differentiated requirements for editing the data processing task. Moreover, since at least part of data processing operations in data processing logic corresponding to the graphical node are executed at a second end, not only resource consumption at the first end may be reduced, but also storage space at the first end may be saved. Furthermore, an execution trigger operation for the data processing task is received and the data processing task is executed according to the execution trigger operation to obtain execution result data of the data processing task so that in a task editing process, convenient viewing of a data processing result is supported to facilitate flexible adjustment of the data processing task, thereby enabling the data processing task to match data processing requirements. According to the technical solution of the embodiments of the present disclosure, visual editing of the data processing task may be realized through simple interactive operations, and data processing resources at multiple ends may be combined to enrich the editing effect of the data processing task, reduce the editing difficulty of the data processing task, broaden the application range of data editing, and improve the editing efficiency of the data processing task.

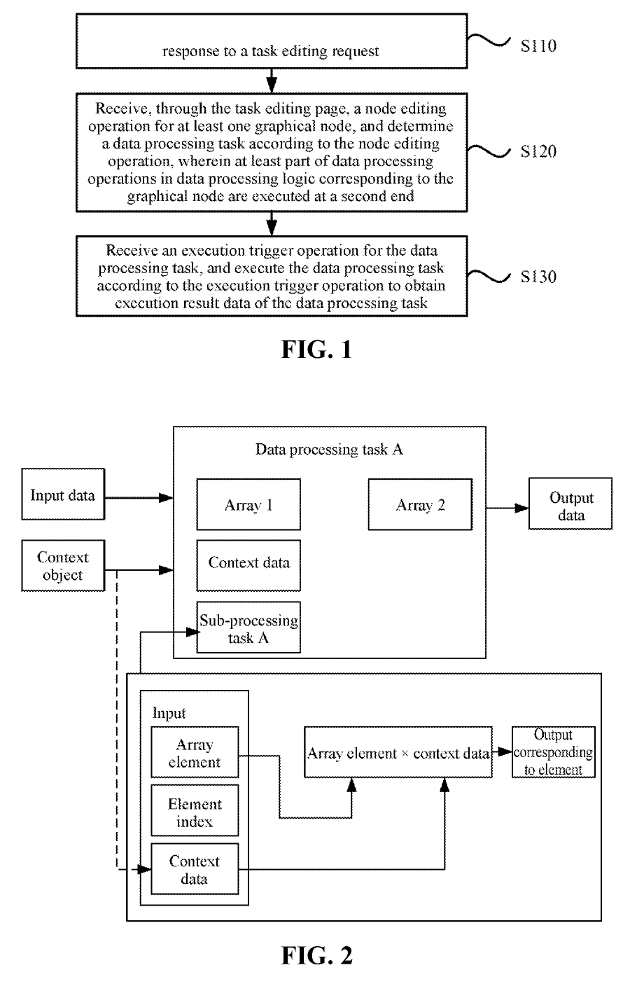

FIG. 1 is a schematic flowchart of a data processing method according to an embodiment of the present disclosure. The embodiment of the present disclosure is applicable to data processing scenarios. The method may be performed by a data processing apparatus, which may be implemented in the form of software and/or hardware. Optionally, the method is implemented by an electronic device, such as a mobile terminal, a personal computer (PC), a server, or the like.

As shown in FIG. 1, the method in this embodiment may specifically include the following steps.

S110: a task editing page is displayed in a browser of a first end in response to a task editing request.

The task editing request may be understood as a request used for triggering execution of an editing process of a data processing task. In practical applications, the task editing request may be generated in a plurality of manners. Exemplarily, the task editing request may be generated in at least one of the following manners: a control trigger operation performed on a preset task editing control, collection of preset audio information, detection of a target trigger event (for example, an operation trigger event), and the like. The data processing task may be understood as a data processing process of performing one or more expected data processing operations on input data to obtain expected output data. That is, the data processing task may be used for data processing logic or a series of data processing steps for transforming input data into expected output data. In an embodiment of the present disclosure, a directed acyclic graph may be used to present the data processing task so that execution logic of the data processing task may be intuitively displayed. In an embodiment of the present disclosure, the data processing task may be set according to actual requirements and is not specifically limited herein. Optionally, the data processing task may be a media data processing task or program data processing task. The media data processing task may include at least one of the following tasks: image-to-video, text-to-video, text-to-image, and text-to-text. The program data processing task may include a program data generation task and/or a program data modification task.

In an embodiment of the present disclosure, the first end may be understood as a client on which a browser is installed and the task editing page may be displayed through the browser. In an embodiment of the present disclosure, the browser installed at the first end may be set according to actual requirements and is not specifically limited herein. The number of browsers included at the first end may be one, two, or more. The task editing page may be understood as a page that is displayed in the browser of the first end and used to edit the data processing task. In an embodiment of the present disclosure, the task editing page may adopt a responsive layout so that page elements may be automatically adjusted in terms of ordering, size, and style based on device information such as the screen size and resolution of a device. In this way, regardless of the device used to access the task editing page, an adaptive page display effect may be obtained, thereby improving the efficiency and convenience of task editing.

In an embodiment of the present disclosure, the task editing page is presented through the browser for the following reasons. First, editors do not need to download or install a dedicated application and can edit the data processing task simply by accessing the task editing page directly through the browser, thereby simplifying the operation process of task editing and reducing the complexity of task editing. Second, editors may access the task editing page anytime and anywhere, thereby effectively improving the flexibility of task editing. Furthermore, since the browser has good cross-platform compatibility and may be adapted to different operating systems and various devices, the task editing page may run stably and smoothly on different operating systems and devices, thereby providing a consistent and good user experience for editors.

In an embodiment of the present disclosure, the browser may at the first end may be in a running state or an idle state. In this case, displaying a task editing page in a browser of a first end in response to a task editing request may include: in response to receiving the task editing request, determining whether a browser is running at the first end; in response to the browser running at the first end, displaying the task editing page in the browser running at the first end; and in response to no browser running at the first end, starting a default browser on the first end and in response to the browser being successfully started, displaying the task editing page in the browser.

In an embodiment of the present disclosure, in the case where the number of browsers included at the first end may be one or more, there are a plurality of manners of displaying a task editing page in a browser of a first end in response to a task editing request. As an optional implementation of the embodiments of the present disclosure, in the case where the first end includes one browser, in response to receiving the task editing request, the task editing page may be displayed in the browser. As another optional implementation of the embodiments of the present disclosure, in the case where the first end includes a plurality of candidate browsers and the task editing request includes a browser identifier, a target browser corresponding to the browser identifier may be selected from the plurality of candidate browsers based on the browser identifier. Furthermore, the task editing page may be displayed in the target browser. The browser identifier may be used to distinguish between different candidate browsers at the first end. As yet another optional implementation of the embodiments of the present disclosure, in the case where the first end includes a plurality of candidate browsers, in response to receiving the task editing request, one browser may be randomly selected from the plurality of candidate browsers as a target browser. Furthermore, the task editing page is displayed in the target browser.

S120: a node editing operation for at least one graphical node is received through the task editing page, and a data processing is determined task according to the node editing operation, where at least part of data processing operations in data processing logic corresponding to the graphical node are executed at a second end.

In an embodiment of the present disclosure, the task editing page may support a relevant person to edit the data processing task in a graphical programming manner. That is, the task editing page may provide an intuitive programming environment for editing the data processing task, where program logic of the data processing task can be constructed by dragging and/or placing graphical nodes. The task editing page may include a plurality of graphical nodes. The graphical node may be understood as a graphical programming node. In an embodiment of the present disclosure, one graphical node may represent an independent functional module and encapsulate data processing logic corresponding to the functional module. The node editing operation may be used to edit node information of the graphical node, and the node information may include at least one of node input data, node output data, and node connection information. Furthermore, the node information may further include at least one of node position, size, color, and the like. The second end may be understood as a device end that is different from the first end. In an embodiment of the present disclosure, the second end may be configured to perform at least part of data processing operations in the data processing logic corresponding to the graphical node. Optionally, the second end may be a remote server. Exemplarily, the remote server may be a cloud. In an embodiment of the present disclosure, the number of second ends may be one, two, or more. In an embodiment of the present disclosure, performing part of data processing operations corresponding to the graphical node at the second end not only may reduce resource consumption at the first end, but also may save storage space at the first end. On this basis, the second end may further deploy a computing cluster with higher performance to process complex data processing operations, thereby effectively improving the efficiency of the data processing task.

In an embodiment of the present disclosure, the task editing page may include or not include a graphical node. There are two manners of receiving a node editing operation for at least one graphical node through the task editing page and determining a data processing task according to the node editing operation.

As an optional implementation of the embodiments of the present disclosure, in the case where the task editing page includes a plurality of graphical nodes, receiving, through the task editing page, a node editing operation for at least one graphical node, and determining a data processing task according to the node editing operation includes: determining a graphical node selected in the task editing page in response to a node selection operation; in response to receiving a node information editing operation for the selected graphical node, obtaining node information of the selected graphical node; and in response to obtaining node information of all graphical nodes in the task editing page, connecting the graphical nodes in the task editing page according to the node information of the graphical nodes to obtain the data processing task.

As another optional implementation of the embodiments of the present disclosure, in the case where the task editing page does not include a graphical node, receiving, through the task editing page, a node editing operation for at least one graphical node, and determining a data processing task according to the node editing operation includes: displaying a graphical programming page, where the graphical programming page may include a plurality of candidate graphical nodes; in response to receiving a node selection operation for a plurality of candidate graphical nodes, determining a plurality of selected graphical nodes; displaying the plurality of selected graphical nodes in the task editing page; connecting the plurality of graphical nodes according to a preset node connection manner of each of the graphical nodes to generate graphical program data; and for each graphical node in the graphical program data, in response to receiving a node information editing operation for the graphical node, obtaining node information of the graphical node, and in response to completing editing of node information of all graphical nodes in the graphical program data, obtaining the data processing task. In an embodiment of the present disclosure, the preset node connection manner may be connected according to actual requirements and is not specifically limited herein. For example, the preset node connection manner may be a selection order of the nodes or display positions of the nodes on the page.

In an embodiment of the present disclosure, the data processing task may include a sub-processing task. The number of sub-processing tasks in the data processing task may be one, two, or more. In an embodiment of the present disclosure, the sub-processing task may be a subtask that needs to be cyclically performed or a subtask that needs to be selectively performed. Optionally, the sub-processing task may include the graphical node that needs to be cyclically performed in the data processing task. The number of graphical nodes that need to be cyclically performed may be one, two, or more. The graphical node in the data processing task may include a subtask entry node and a subtask exit node that are connected to the sub-processing task. The subtask entry node may be used to convert a plurality of data that need to be processed by the sub-processing task into input data in a first preset format. The subtask exit node may be used to merge a plurality of data output by the sub-processing task into output data in a second preset format. The first format and the second format may be respectively set according to actual requirements and are not specifically limited herein. The first format and the second format may be the same or different. Exemplarily, the first format may be an array format and the second format may also be an array format. Alternatively, the first format is an array format and the second format may be a string format.

Exemplarily, referring to FIG. 2, input data is [1, 2, 3], that is, array 1. Context data corresponding to a context object is 2. Data processing task A is to perform multiplication between the context data and each array element in the array. In data processing task A, the logic requiring cyclic processing is the multiplication between the context data and the array element, that is, sub-processing task A that needs to be cyclically performed. In this case, after the input data [1, 2, 3] and the context data 2 are respectively input into data processing task A, array element 1 whose index is 1 is first obtained through sub-processing task A, and array element 1 and the context data 2 are multiplied to obtain a multiplication result 2. Then, array element 2 whose index is 2 is obtained through sub-processing task A, and array element 2 and the context data 2 are multiplied to obtain a multiplication result 4. Finally, array element 3 whose index is 3 is obtained through sub-processing task A, and array element 3 and the context data 2 are multiplied to obtain a multiplication result 6. Furthermore, an output [2, 4, 6] corresponding to the elements, referred to as array 2, may be obtained. In this case, array 2 is output data of data processing task A.

S130: an execution trigger operation for the data processing task is received and the data processing task is executed according to the execution trigger operation to obtain execution result data of the data processing task.

The execution trigger operation may be understood as an operation for triggering execution of the data processing task. In an embodiment of the present disclosure, receiving an execution trigger operation for the data processing task may specifically be receiving a control trigger operation (for example, a click trigger operation) performed on a task execution control. The task execution control may be displayed on the task editing page. In other words, the task editing page includes the task execution control. The execution result data may be understood as result data obtained after the data processing task is executed. In an embodiment of the present disclosure, the execution result data may include media data and/or program data. The media data may include at least one of video data, audio data, and image data. The program data may include a class and/or a method. The program data may include one or more classes. A single class may include a method and/or a variable.

Specifically, after the control trigger operation performed on the task execution control in the task editing page is received, a task execution instruction for the data processing task may be generated at the first end. Furthermore, the data processing task may be executed based on the task execution instruction to obtain the execution result of the data processing task. In an embodiment of the present disclosure, executing the data processing task to obtain the execution result data of the data processing task includes: determining a node execution order of the graphical nodes according to a connection relationship between the graphical nodes in the data processing task; and sequentially executing data processing logic corresponding to the graphical nodes according to the node execution order to obtain the execution result data of the data processing task. The node execution order may be used to represent a sequence of executing the graphical nodes.

In an embodiment of the present disclosure, sequentially executing data processing logic corresponding to the graphical nodes according to the node execution order to obtain the execution result data of the data processing task may include: determining, according to the node execution order, a graphical node to be executed at a current moment and using the graphical node as a current node; determining that the data processing logic corresponding to the current node is deployed at the second end; in response to the data processing logic corresponding to the current node being deployed at the second end, generating an execution instruction for the current node at the first end and sending the execution instruction to the second end; in response to the second end receiving the execution instruction, executing the data processing logic corresponding to the current node and feeding back a processing result to the first end; in response to the first end receiving the processing result fed back by the second end, determining, according to the node execution order, a graphical node to be executed at a next moment; using the processing result fed back by the second end as input data of the graphical node to be executed at the next moment; and updating the current node to the graphical node to be executed at the next moment, and re-executing the operation of determining that the data processing logic corresponding to the current node is deployed at the second end. It should be understood that in the case where the data processing logic of the graphical node is deployed at the first end and not deployed at the second end, the data processing logic of the graphical node may be executed at the first end.

Based on the foregoing embodiments, the data processing logic corresponding to the graphical node may include first processing sub-logic deployed at the first end and second processing sub-logic deployed at the second end. In response to input data of the first processing sub-logic being an output result of the second processing sub-logic, executing the data processing logic corresponding to the graphical node includes: first generating an execution instruction of the second processing sub-logic at the first end and sending the execution instruction to the second end; in response to the second end receiving the execution instruction, executing the second processing sub-logic to obtain the output result of the second processing sub-logic; in response to the second end obtaining the output result of the second processing logic, feeding back the output result to the first end; and in response to the first end receiving the output result of the second processing logic, assigning the output result as an actual parameter to an entry parameter of the first processing logic and executing the first processing logic to obtain an output result of the first processing logic, that is, obtain output data corresponding to the graphical node.

In an embodiment of the present disclosure, the execution result data of the data processing task may include media data. The graphical node in the data processing task includes a data rendering node. The data rendering node may be configured set a data rendering template and template input data of the data rendering template. In an embodiment of the present disclosure, the data rendering template may be used to render the template input data into media data having an expected presentation effect. In an embodiment of the present disclosure, data processing logic corresponding to the data rendering template may be executed at the second end to improve rendering processing efficiency. In an embodiment of the present disclosure, in the case where the data processing task includes a plurality of data rendering nodes, the second ends that execute data processing logic corresponding to different data rendering nodes may be the same or different. That is, the second ends corresponding to different data rendering nodes may be the same or different. Exemplarily, the graphical node in the data processing task includes data rendering node 1 and data rendering node 2. Data processing logic corresponding to data rendering node 1 is executed at second end A, and data processing logic corresponding to data rendering node 2 is executed at second end B. Alternatively, the data processing logic corresponding to data rendering node 1 and the data processing logic corresponding to data rendering node 2 are both executed at second end A. In an embodiment of the present disclosure, in response to the data processing task including an image-to-video task, the execution result of the data processing task is video data. Exemplarily, if task description data of the data processing task is "please generate a video of a small fish swimming in water", the execution result data of the data processing task is a video of a small fish swimming in water.

In an embodiment of the present disclosure, the data rendering template set by the data rendering node may be set according to actual requirements and is not specifically limited herein. In the case where there are a plurality of data rendering nodes, the data rendering templates set by different data rendering nodes may be the same or different. Based on the foregoing embodiments, a manner of setting the data rendering template for the data rendering node may specifically include: displaying at least one candidate data rendering template corresponding to the data rendering node; and in response to a template selection operation for a candidate data rendering template, using the selected data rendering template as the data rendering template of the data rendering node. Furthermore, after the data rendering template corresponding to the data rendering node is set, the method may further include: in response to data rendering template being not configured with template input data, receiving a data setting operation for inputting the data rendering template so that the data rendering template is set with template input data; or in the case where the data rendering template is set with template input data, receiving a data modification operation for the template input data to update the template input data of the data rendering template; or in the case where the data rendering template is set with default template input data, determining the default template input data set by the data rendering template as the template input data of the data rendering template.

In an embodiment of the present disclosure, the execution result data of the data processing task may include program data. The graphical node in the data processing task may include a string processing node. The string processing node may be used to adjust input program data and/or request the second end to generate program data according to node input data of the string processing node. That is, the string processing node may be used to adjust the input program data. Exemplarily, the string node may be used to modify the input program data from a first programming language to a second programming language, add part of program data to the input program data, delete part of program data from the input program data, modify part of program data in the input program data, combine different program data, and the like. In an embodiment of the present disclosure, the string processing node may be used to request the second end to generate the program data according to the node input data of the string processing node. Specifically, after the node input data of the string processing node is determined, the node input data may be sent to the second end. After receiving the node input data, the second end may generate the program data according to the input data and feed back the program data to the first end to obtain node output data, that is, the program data, of the string processing node.

In an embodiment of the present disclosure, the data processing task may include at least one execution link task. The execution link task may be determined based on a graphical node serving as a task input node in the data processing task. The task input node may be understood as an input node of the data processing task. In an embodiment of the present disclosure, the graphical node corresponding to the execution link task may be determined based on the graphical node that is the task input node in the data processing task and a graphical node that is a task output node. The task output node may be understood as an output node of the data processing task. The graphical node corresponding to the execution link task includes the graphical node that is the task input node and the graphical node that is the task output node in the data processing task, and a graphical node located between the graphical node that is the task input node and the graphical node that is the task output node. On this basis, after receiving the execution trigger operation for the data processing task, the method may further include: in response to a task cancel request for the execution link task, determining a plurality of graphical nodes corresponding to the execution link task, and sending a cancel instruction to the plurality of graphical nodes corresponding to the execution link task to cause the graphical node to stop executing the data processing operation corresponding to the graphical node.

The task cancel request may be understood as a request for canceling execution of the data processing task in the case where the execution of the data processing task is triggered. In an embodiment of the present disclosure, there are a plurality of manners of obtaining the task cancel request, which is not specifically limited herein. For example, the task cancel request may be generated in at least one of the following manners: a control trigger operation performed on a preset task cancel control, collection of preset audio information, detection of a target trigger event (for example, an operation trigger event), and the like.

Specifically, after receiving the execution trigger operation for the data processing task, in response to receiving the task cancel request for the execution link task, the plurality of graphical nodes corresponding to the execution link task may be determined according to a correspondence between the execution link task and the graphical nodes. In the case where the plurality of graphical nodes corresponding to the execution link task are determined, a cancel instruction may be generated and sent to the plurality of graphical nodes corresponding to the execution link task to cause the graphical node to stop executing the data processing operation corresponding to the graphical node.

Based on the foregoing embodiments, before determining the plurality of graphical nodes corresponding to the execution link task, the method may further include: determining task input nodes among the plurality of graphical nodes in the data processing task, and for each of the task input nodes, using the task input node as a root node, constructing a tree structure corresponding to the task input node according to connection relationships between the plurality of graphical nodes in the data processing task. In an embodiment of the present disclosure, a tree structure is established for each execution link task so that the plurality of graphical nodes included in the execution link may be more quickly and accurately determined, thereby facilitating quick response of the plurality of graphical nodes in the execution link to a task processing request, such as a task cancel request.

In an embodiment of the present disclosure, determining the task input nodes among the plurality of graphical nodes in the data processing task may specifically include: for each of the plurality of graphical nodes in the data processing task, determining an in-degree of the graphical node; and in the case where the in-degree of the graphical node is zero, determining the graphical node as the task input node among the plurality of graphical nodes in the data processing task.

In an embodiment of the present disclosure, for each of the task input nodes, using the task input node as a root node, constructing a tree structure corresponding to the task input node according to the connection relationships between the plurality of graphical nodes in the data processing task includes: for each of the task input nodes, using the task input node as a root node; and determining, according to the connection relationship between the plurality of graphical nodes in the data processing task, a graphical node directly connected to the root node; determining a child node of the root node as the graphical node directly connected to the root node; and after the child node corresponding to the root node is determined, using the child node as the root node, and re-executing the operation of determining, according to the connection relationships between the plurality of graphical nodes in the data processing task, a graphical node directly connected to the root node, to obtain the tree structure corresponding to the task input node.

In an embodiment of the present disclosure, after the tree structure corresponding to the task input node is constructed, in response to the task cancel request for the execution link task, determining the plurality of graphical nodes corresponding to the execution link task includes: in response to the task cancel request for the execution link task, determining a task input node corresponding to the execution link task, and determining the plurality of graphical nodes in the tree structure corresponding to the task input node as the plurality of graphical nodes corresponding to the execution link task.

Specifically, after the task cancel request for the execution link task is received, a graphical node whose in-degree is zero in the execution link task, that is, the task input node corresponding to the execution link task may be determined according to the connection relationship between the plurality of graphical nodes in the execution link task. After the task input node is determined, the tree structure corresponding to the task input node may be traversed to determine a graphical node that is a leaf node in the tree structure. After the graphical node that is the leaf node is determined, a cancel instruction may be sent to the graphical node that is the leaf node to cause the graphical node that is the leaf node to stop executing the data processing operation corresponding to the graphical node, that is, task execution of the execution link task is canceled. The advantage of such processing is that the execution link task may be canceled only by terminating the operation of the leaf node, thereby realizing precise control of the execution of the execution link task.

According to the technical solution of the embodiments of the present disclosure, a task editing page is displayed in a browser of a first end in response to a task editing request so that the task editing page is displayed through the browser without installing specific software to edit a task, and a visual presentation of task editing may be realized to provide an interactive interface for task editing operations. Then, a node editing operation for at least one graphical node is received through the task editing page and a data processing task is determined according to the node editing operation so that the difficulty in editing the data processing task is reduced and flexible editing of an output processing task may be realized to meet differentiated requirements for editing the data processing task. Moreover, since at least part of data processing operations in data processing logic corresponding to the graphical node are executed at a second end, not only resource consumption at the first end may be reduced, but also storage space at the first end may be saved. Furthermore, an execution trigger operation for the data processing task is received and the data processing task is executed according to the execution trigger operation to obtain execution result data of the data processing task so that in a task editing process, convenient viewing of a data processing result is supported to facilitate flexible adjustment of the data processing task, thereby enabling the data processing task to match data processing requirements. According to the technical solution of the embodiments of the present disclosure, visual editing of the data processing task may be realized through simple interactive operations, and data processing resources at multiple ends may be combined to enrich the editing effect of the data processing task, reduce the editing difficulty of the data processing task, broaden the application range of data editing, and improve the editing efficiency of the data processing task.

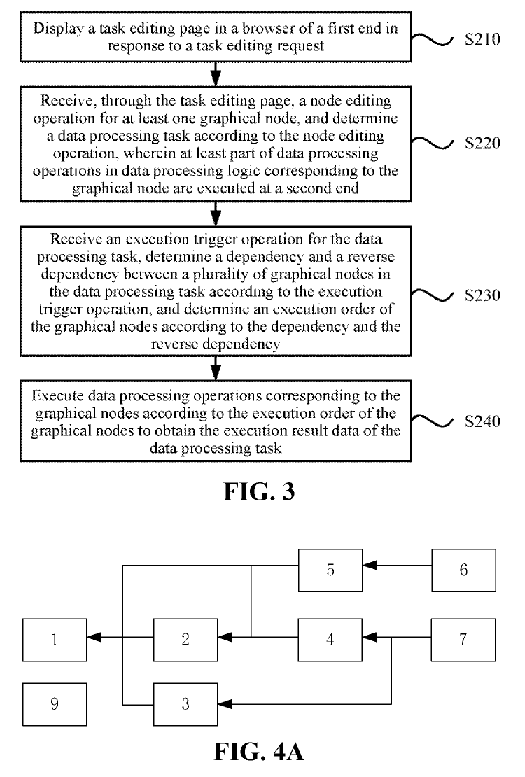

FIG. 3 is a schematic flowchart of another data processing method according to an embodiment of the present disclosure. Based on the foregoing embodiments, the technical solution of this embodiment further details the manner of executing the data processing task to obtain the execution result data of the data processing task. Optionally, executing the data processing task to obtain the execution result data of the data processing task includes: determining a dependency and a reverse dependency between a plurality of graphical nodes in the data processing task and determining an execution order of the graphical nodes according to the dependency and the reverse dependency; and executing data processing operations corresponding to the graphical nodes according to the execution order of the graphical nodes to obtain the execution result data of the data processing task. For the specific implementation, reference may be made to the description of this embodiment. The technical features the same as or similar to those in the foregoing embodiments are not described herein again. As shown in FIG. 3, the method in this embodiment may specifically include the following steps.

S210: a task editing page is displayed in a browser of a first end in response to a task editing request.

S220: a node editing operation for at least one graphical node is received through the task editing page and a data processing task is determined according to the node editing operation, where at least part of data processing operations in data processing logic corresponding to the graphical node are executed at a second end.

S230: an execution trigger operation for the data processing task is received and a dependency and a reverse dependency are determined between a plurality of graphical nodes in the data processing task according to the execution trigger operation, and determining an execution order of the graphical nodes according to the dependency and the reverse dependency.

The dependency may be used to indicate a graphical node on which the graphical node depends. The reverse dependency may be used to indicate a graphical node that depends on the graphical node. Specifically, after receiving the execution trigger operation for the data processing task, the dependency and the reverse dependency between the plurality of graphical nodes in the data processing task may be determined according to the execution trigger operation and based on a connection relationship between the plurality of graphical nodes in the data processing task. Furthermore, the execution order of the graphical nodes may be determined according to the dependency and the reverse dependency.

In an embodiment of the present disclosure, determining the execution order of the graphical nodes according to the dependency and the reverse dependency includes: establishing a dependency table according to the dependency corresponding to the plurality of graphical nodes; and establishing a reverse dependency table according to the reverse dependency corresponding to the plurality of graphical nodes; determining the graphical node that has no dependency in the dependency table as a first node and executing a data processing operation corresponding to the first node; and in response to an event that the data processing operation corresponding to the first node is completed, deleting the first node from the dependency table and determining, from the plurality of graphical nodes, a second node that depends on the first node according to the reverse dependency table; and re-determining the first node from the second node according to the dependency table in which the first node is deleted and returning to executing the operation of executing the data processing operation corresponding to the first node.

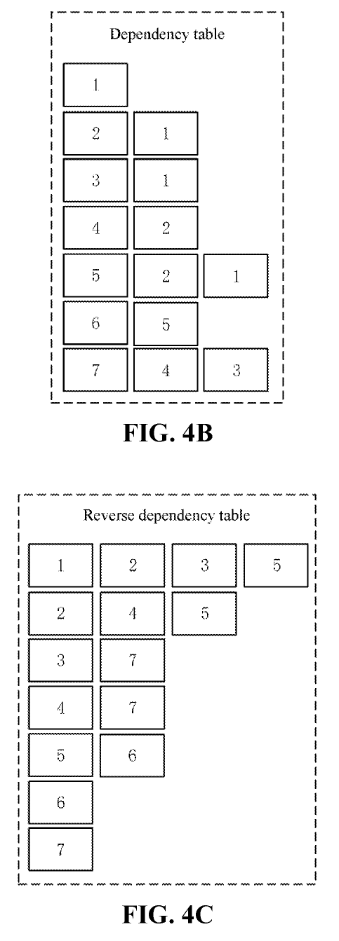

Exemplarily, referring to FIG. 4A, the plurality of graphical nodes in the data processing task may include node 1, node 2, node 3, node 4, node 5, node 6, and node 7. Node 2 depends on node 1, node 3 depends on node 1, node 4 depends on node 2, node 5 depends on node 2, node 6 depends on node 5, and node 7 depends on node 3 and node 4. In this case, the dependency table is shown in FIG. 4B. Node 1 is depended on by node 2, node 3, and node 5. Node 2 is depended on by node 4 and node 5. Node 3 is depended on by node 7. Node 4 is depended on by node 7. Node 5 is depended on by dependent node 6. In this case, the reverse dependency table is shown in FIG. 4C.

It should be noted that in an embodiment of the present invention, since an independent node has no actual input or output dependency, the existence of the independent node wastes computing resources and the independent node may be deleted to release redundant resources. In this case, in the case where an independent graphical node exists among the plurality of graphical nodes in the data processing task, the independent graphical node may be deleted to reduce resource occupancy, optimize task execution efficiency, and improve the accuracy of the task result. Before the data processing task is executed, the independent node in the data processing task may be deleted. For example, referring to FIG. 4A, node 9 is an independent graphical node and may be deleted before the data processing task is executed.

Specifically, the dependency table is established according to the dependency corresponding to the plurality of graphical nodes; and the reverse dependency table is established according to the reverse dependency corresponding to the plurality of graphical nodes. After the dependency table and the reverse dependency table are obtained, the graphical node that has no dependency in the dependency table may be determined. Furthermore, the graphical node that has no dependency in the dependency table may be determined as the first node. After the first node is determined, the data processing operation corresponding to the first node may be executed. In response to the event that the data processing operation corresponding to the first node is completed, the first node may be deleted from the dependency table. After the first node is deleted from the dependency, the second node that depends on the first node may be determined, from the plurality of graphical nodes, according to the reverse dependency table. Furthermore, the first node may be re-determined from the second node according to the dependency table in which the first node is deleted, and the operation of executing the data processing operation corresponding to the first node is returned to.

Continuing with the above example, after the dependency table (referring to FIG. 4B) and the reverse dependency table (referring to FIG. 4C) are obtained, the graphical node that has no dependency in the dependency table is node 1, that is, the first node. The data processing operation corresponding to node 1 is executed. After the data processing operation corresponding to node 1 is completed, node 1 in the dependency table may be deleted. Then it may be determined from the reverse dependency table that the graphical nodes that depend on node 1 are node 2, node 3, and node 5, that is, the second node includes node 2, node 3, and node 5. In the dependency table in which node 1 is deleted, the graphical nodes in which the dependency does not exist, that is, node 2 and node 3, are re-determined from node 2, node 3, and node 5. Then, the data processing operations corresponding to node 2 and node 3 are respectively executed. After the execution is completed, node 2 and node 3 in the dependency table are deleted. Then the graphical nodes that depend on node 2, that is, node 4 and node 5, are determined from the reverse dependency table, and the graphical node that depends on node 3, that is, node 7, is determined. In this case, the second node includes node 4, node 5, and node 7. In the dependency table in which node 1, node 2, and node 3 are deleted, it may be determined that the graphical nodes that have no dependency in node 4, node 5, and node 7 are node 4 and node 5. Furthermore, the data processing operations corresponding to node 4 and node 5 are respectively executed. After the execution is completed, node 4 and node 5 are deleted again from the dependency table in which node 1, node 2, and node 3 are deleted. Then the graphical node that depends on node 4, that is, node 7, is determined from the reverse dependency table, and the graphical node that depends on node 5, that is, node 6, is determined. In this case, the second node includes node 7 and node 6. The graphical nodes in which the dependency does not exist, that is, node 6 and node 7, are determined in the dependency table in which node 1, node 2, node 3, node 4, and node 5 are deleted. Then node 6 and node 7 may be executed. That is, the execution order of the plurality of graphical nodes in the data processing task in FIG. 4A may be as follows: the graphical node that needs to be executed for the first time includes node 1, the graphical nodes that need to be executed for the second time include node 2 and node 3, the graphical nodes that need to be executed for the third time include node 4 and node 5, and the graphical nodes that need to be executed for the fourth time include node 6 and node 7.

S240: the data processing operations corresponding to the graphical nodes are executed according to the execution order of the graphical nodes to obtain the execution result data of the data processing task.

Specifically, after the execution order of the graphical nodes is determined, the data processing operations corresponding to the graphical nodes may be executed according to the execution order of the graphical nodes. After the data processing operations corresponding to all the graphical nodes are executed, the execution result data of the data processing task may be obtained.

According to the technical solution of the embodiments of the present disclosure, a dependency and a reverse dependency between a plurality of graphical nodes in the data processing task are determined, and an execution order of the graphical nodes is determined according to the dependency and the reverse dependency; and data processing operations corresponding to the graphical nodes are executed according to the execution order of the graphical nodes to obtain the execution result data of the data processing task so that the execution order of the graphical nodes is accurately determined and the execution result data of the data processing task may be effectively obtained according to the execution order.

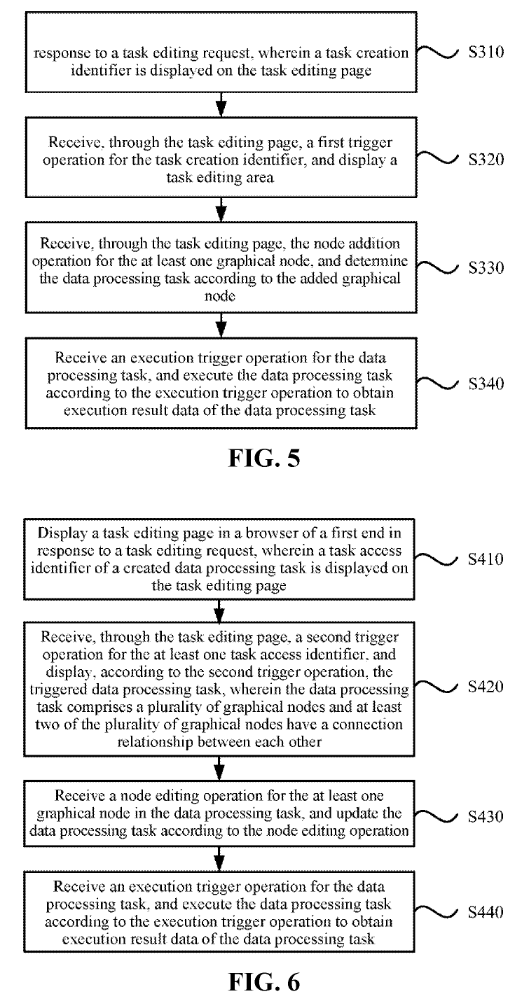

FIG. 5 is a schematic flowchart of another data processing method according to an embodiment of the present disclosure. Based on the foregoing embodiments, the technical solution of this embodiment further details the manner of receiving a node editing operation for at least one graphical node through the task editing page and determining a data processing task according to the node editing operation. Optionally, the task editing page displays a task creation identifier, the node editing operation includes at least a node addition operation, and receiving a node editing operation for at least one graphical node through the task editing page and determining a data processing task according to the node editing operation includes: receiving a first trigger operation for the task creation identifier through the task editing page and displaying a task editing area; and receiving a node addition operation for at least one graphical node through the task editing area and determining a data processing task according to the added graphical node. For the specific implementation, reference may be made to the description of this embodiment. The technical features the same as or similar to those in the foregoing embodiments are not described herein again. As shown in FIG. 5, the method in this embodiment may specifically include the following steps.

S310: a task editing page is displayed in a browser of a first end in response to a task editing request, where the task editing page displays a task creation identifier.

The task creation identifier may be understood as an identifier used to display the task editing area on the task editing page. In an embodiment of the present disclosure, a display position of the task creation identifier on the task editing page may be set according to actual requirements and is not specifically limited herein. For example, the task creation identifier may be displayed at the top, sidebar, or bottom of the task editing page. In an embodiment of the present disclosure, the task creation identifier may be presented in the form of an icon, a label, a text box, or the like. Optionally, the task creation identifier may be a task creation control.

S320: a first trigger operation for the task creation identifier is received through the task editing page and a task editing area is displayed.

The first trigger operation may be understood as an operation used to trigger the task creation identifier to display the task editing area on the task editing page. In an embodiment of the present disclosure, the task editing area may be presented in a plurality of forms, which is not specifically limited herein. Exemplarily, the task editing area may be a window popped up on the task editing page. Alternatively, the task editing area may be a view area embedded in the task editing page. Alternatively, the task editing page may be used as a reference page and a new page is jumped to as the task editing area. Alternatively, the task editing area may be a hidden panel which, after receiving the first trigger operation, slides to a visible area of the task editing page. Still alternatively, the task editing area may be an area corresponding to a preset tab page in the task editing page.

As an optional implementation of the embodiments of the present disclosure, in response to receiving the first trigger operation performed on the task creation identifier in the task editing page, a window is popped up on the task editing page as the task editing area. Alternatively, a view area with a specific size preset on the task editing page may be used as the task editing area. Alternatively, the task editing page is used as a reference page and a new page is jumped to as the task editing area. Alternatively, a hidden task editing panel is slid to and displayed in the visible area of the task editing page.

As another optional implementation of the embodiments of the present disclosure, the task editing page includes a plurality of preset tab pages, and different preset tab pages correspond to different areas. The task editing area corresponds to a target tab page of the plurality of preset tab pages. In response to receiving the first trigger operation performed on the target tab page, the task editing area corresponding to the target tab page may be displayed in the task editing page so that a relevant person may add a graphical node to the task editing area.

S330: a node addition operation for at least one graphical node is received through the task editing area and a data processing task is determined according to the added graphical node.

At least part of data processing operations in data processing logic corresponding to the graphical node are executed at the second end. In an embodiment of the present disclosure, the node addition operation may be understood as an operation used to add the graphical node to the task editing area to obtain a plurality of graphical nodes corresponding to the data processing task. Compared with the prior art in which the data processing task is obtained by writing program code, in an embodiment of the present disclosure, a node addition operation for at least one graphical node is received through the task editing area and a data processing task is determined according to the added graphical node. In this manner, there is no need to write program code and the data processing task may be quickly built simply by adding graphical nodes through an intuitive graphical interface, thereby reducing the difficulty in building the data processing task. Furthermore, when a requirement for the data processing task changes, a node or a connection relationship may be directly adjusted in the graphical interface without modifying underlying code, thereby reducing maintenance costs.

Specifically, the node addition operation for the at least one graphical node is received through the task editing area. Furthermore, the added graphical node may be determined based on the node addition operation. After the added graphical node is determined, the data processing task may be determined based on the added graphical node. In an embodiment of the present disclosure, a plurality of graphical nodes are added, and there are a plurality of manners of determining the data processing task based on the added graphical nodes. For example, the plurality of graphical nodes may be connected based on an addition sequence of the plurality of added graphical nodes to obtain the data processing task. Alternatively, in response to a node connection operation for the plurality of added graphical nodes, the data processing task may be obtained based on the node connection operation, and the node connection operation may be understood as an operation used to connect the plurality of added graphical nodes.

Exemplarily, after the task editing area is displayed, a plurality of candidate graphical nodes are displayed in the task editing area. After a node selection operation is performed on the plurality of candidate graphical nodes, the selected graphical nodes may be sequentially displayed in the task editing area. In the case where all the selected graphical nodes are displayed in the task editing area, the data processing task may be obtained based on the plurality of selected graphical nodes.

S340: an execution trigger operation for the data processing task is received and the data processing task is executed according to the execution trigger operation to obtain execution result data of the data processing task.

According to the technical solution of the embodiments of the present disclosure, a first trigger operation for the task creation identifier is received through the task editing page and a task editing area is displayed; and a node addition operation for at least one graphical node is received through the task editing area and a data processing task is determined according to the added graphical node. In this manner, the function of building the data processing task by adding the graphical node through an intuitive graphical interface is implemented.

FIG. 6 is a schematic flowchart of another data processing method according to an embodiment of the present disclosure. Based on the foregoing embodiments, the technical solution of this embodiment further details the manner of receiving, through the task editing page, a node editing operation for at least one graphical node, and determining a data processing task according to the node editing operation. Optionally, the task editing page displays a task access identifier of a created data processing task, and receiving, through the task editing page, a node editing operation for at least one graphical node, and determining a data processing task according to the node editing operation includes: receiving, through the task editing page, a second trigger operation for at least one task access, identifier and displaying a triggered data processing task according to the second trigger operation, where the data processing task includes a plurality of graphical nodes and at least two of the plurality of graphical nodes have a connection relationship between each other; and receiving a node editing operation for the at least one graphical node in the data processing task and updating the data processing task according to the node editing operation. For the specific implementation, reference may be made to the description of this embodiment. The technical features the same as or similar to those in the foregoing embodiments are not described herein again. As shown in FIG. 6, the method in this embodiment may specifically include the following steps.

S410: a task editing page is displayed in a browser of a first end in response to a task editing request, where the task editing page displays a task access identifier of a created data processing task.

In an embodiment of the present disclosure, the task editing page may provide the task access identifier of the created data processing task. In this manner, the setup flow of the data processing task may be simplified. Instead of going through the cumbersome steps of creating a new data processing task, a relevant person may quickly locate the created data processing task based on the task access identifier and directly perform secondary editing on the created data processing task, thereby improving the efficiency of the data processing task. In an embodiment of the present disclosure, the task access identifier may be used to distinguish between different created data processing tasks. The number of task access identifiers in the task editing page may be one, two, or more. In an embodiment of the present disclosure, the task access identifier may include a graphical identifier and/or a text identifier.

In an embodiment of the present disclosure, a display manner of the task access identifier of the created data processing task on the task editing page may be set according to actual requirements and is not specifically limited herein. Exemplarily, a plurality of task access identifiers are presented in the form of a vertical list, and each task access identifier occupies one line of the list. Alternatively, each task access identifier is presented in the form of a card. Alternatively, each task access identifier is presented in the form of a label, and a size and a color of the label may be set according to actual requirements and are not specifically limited herein.

In an embodiment of the present disclosure, in response to receiving the task editing request, the task editing page may be displayed in the browser of the first end. After the task editing page is displayed in the browser of the first end, the task access identifier of the created data processing task is determined and the task access identifier is directly displayed on the task editing page. Alternatively, after the task editing page is displayed in the browser of the first end, in response to receiving a data processing task setup operation for the task editing page, the task access identifier of the created data processing task is determined and the task access identifier is displayed on the task editing page. The data processing task setup operation may be understood as an operation used to trigger setup of the data processing task.

S420: a second trigger operation for at least one task access identifier is received through the task editing page and displaying a triggered data processing task according to the second trigger operation, where the data processing task includes a plurality of graphical nodes and at least two of the plurality of graphical nodes have a connection relationship between each other.

The second trigger operation may be understood as a trigger operation performed on the task access identifier. At least part of data processing operations in data processing logic corresponding to the graphical node are executed at the second end.

Specifically, in response to receiving the second trigger operation performed on the at least one task access identifier in the task editing page, a triggered task access identifier may be determined. Furthermore, a data processing task corresponding to the triggered task access identifier may be determined according to a correspondence between the task access identifier and the data processing task, that is, the triggered data processing task is determined. Furthermore, the triggered data processing task may be displayed on the task editing page, that is, a plurality of graphical nodes, of which there is a connection relationship between at least two graphical nodes, included in the data processing task are displayed on the task editing page.

S430: a node editing operation for at least one graphical node in the data processing task is received and the data processing task is updated according to the node editing operation.

The node editing operation may be understood as an operation used to edit one or more graphical nodes in the data processing task. The node editing operation may be an operation used to edit node information of the at least one graphical node in the data processing task, and/or the node editing operation may be an operation used to edit a connection relationship between respective graphical nodes. In an embodiment of the present disclosure, there are a plurality of manners of receiving the node editing operation for the at least one graphical node in the data processing task and updating the data processing task according to the node editing operation.

As an optional implementation of the embodiments of the present disclosure, in response to a first node selection operation for a plurality of graphical nodes in the data processing task, selected graphical nodes are determined. In response to receiving a node information modification operation for the selected graphical nodes, node information of the selected graphical nodes may be modified according to the node information modification operation to obtain an updated data processing task.

As an optional implementation of the embodiments of the present disclosure, in response to receiving a second node selection operation for two graphical nodes in the data processing task, two selected graphical nodes are determined. In response to receiving a connection relationship modification operation and/or a connection relationship setup operation for the two selected graphical nodes, a connection relationship between the two selected graphical nodes may be modified and/or setup to obtain an updated data processing task.

S440: an execution trigger operation for the data processing task is received and the data processing task is executed according to the execution trigger operation to obtain execution result data of the data processing task.

According to the technical solution of the embodiments of the present disclosure, a second trigger operation for at least one task access identifier is received through the task editing page and a triggered data processing task is displayed according to the second trigger operation, where the data processing task includes a plurality of graphical nodes and there is a connection relationship between at least two graphical nodes; and a node editing operation for at least one graphical node in the data processing task is received and the data processing task is updated according to the node editing operation. In this manner, the function of obtaining a required data processing task by performing secondary editing on a data processing task is implemented.

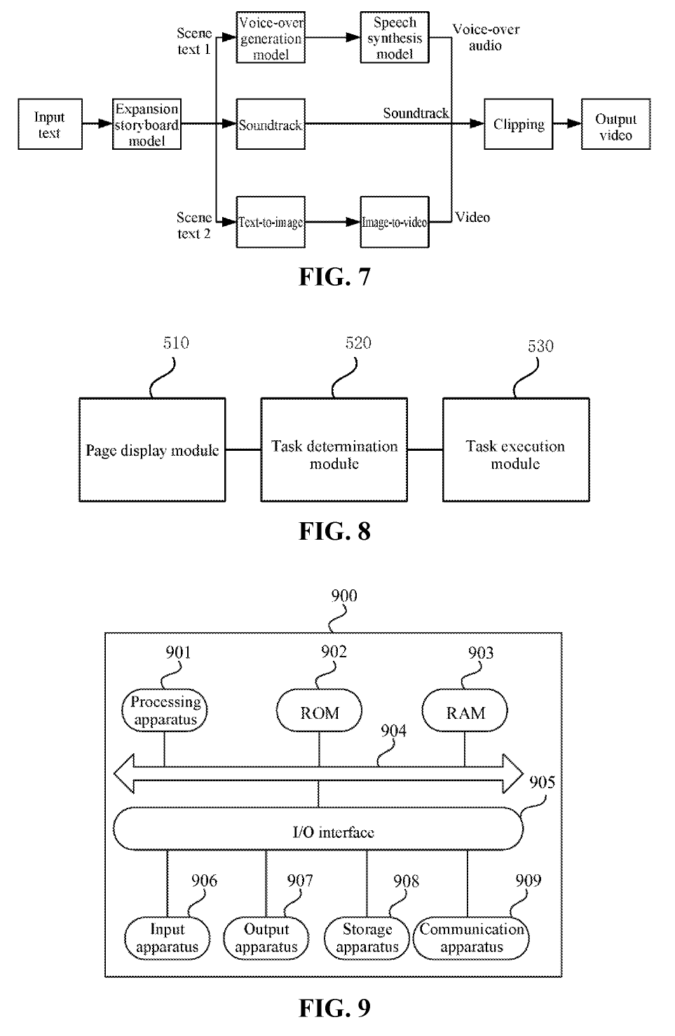

As an optional embodiment of the embodiments of the present disclosure, referring to FIG. 7, an embodiment of the present disclosure provides a data processing method for generating video data based on text data, that is, a data processing task is a text-to-video task. Data processing steps for the text-to-video task include the following steps.

Step 1: in response to receiving a task editing request through a first end, a task editing page may be displayed in a browser of the first end. In response to receiving a node editing operation for at least one graphical node in the task editing page, a text-to-video data processing task may be obtained. In an embodiment of the present disclosure, graphical nodes of the text-to-video data processing task include input text, an expansion storyboard model, a voice-over generation model, a soundtrack, text-to-image, a speech synthesis model, image-to-video, clipping, and output video. Data processing logic corresponding to the expansion storyboard model, the voice-over generation model, the soundtrack, text-to-image, the speech synthesis model, image-to-video, and clipping is executed at a second end.

Step 2: in response to receiving an execution trigger operation for the text-to-video data processing task, text data may be received through the graphical node, acting as the input text, in the first end. After that, the first end sends the text data to the second end so that the second end calls the expansion storyboard model to process the text data to obtain scene text 1 and scene text 2. After obtaining scene text 1, the second end may execute the voice-over generation model to process scene text 1 and then execute the speech synthesis model to process an output result of the voice-over generation model to obtain a voice-over audio. After obtaining scene text 2, the second end may execute data processing logic of text-to-image to process scene text 2 and then execute data processing logic of image-to-video to process image data obtained based on scene text 2 to obtain a video. The second end executes data processing logic of the soundtrack to process a processing result of the expansion storyboard model to obtain a soundtrack. In the case where the second end obtains the voice-over audio, the soundtrack, and the video, clipping logic of the second end may be executed to process the voice-over audio, the soundtrack, and the video to obtain a processed video, that is, the output video. After obtaining the processed video, the second end may send the processed video to the first end.

Step 3: in response to receiving the video sent by the second end, the first end may present the video in the browser page of the first end.

The technical solution of the embodiments of the present disclosure solves the technical problem of high difficulty and time consumption in writing caused by data processing through writing program data in the related art, and enables media data to be processed more intuitively, flexibly, and conveniently by combining data processing resources at multiple ends, thereby reducing the difficulty in processing the media data and improving the processing efficiency of the media data.

FIG. 8 is a schematic diagram illustrating the structure of a data processing apparatus according to an embodiment of the present disclosure. As shown in FIG. 8, the apparatus includes a page display module 510, a task determination module 520, and a task execution module 530. The page display module 510 is configured to display a task editing page in a browser of a first end in response to a task editing request; the task determination module 520 is configured to receive, through the task editing page, a node editing operation for at least one graphical node, and determine a data processing task according to the node editing operation, where at least part of data processing operations in data processing logic corresponding to the graphical node are executed at a second end; and the task execution module 530 is configured to receive an execution trigger operation for the data processing task and execute the data processing task according to the execution trigger operation to obtain execution result data of the data processing task.

According to the technical solution of the embodiments of the present disclosure, the page display module 510 displays a task editing page in a browser of a first end in response to a task editing request so that the task editing page is displayed through the browser without installing specific software to edit a task, and a visual presentation of task editing may be realized to provide an interactive interface for task editing operations. Then, the task determination module 520 receives a node editing operation for at least one graphical node through the task editing page and determines a data processing task according to the node editing operation so that the difficulty in editing the data processing task is reduced and flexible editing of an output processing task may be realized to meet differentiated requirements for editing the data processing task. Moreover, since at least part of data processing operations in data processing logic corresponding to the graphical node are executed at a second end, not only resource consumption at the first end may be reduced, but also storage space at the first end may be saved. Furthermore, the task execution module 530 receives an execution trigger operation for the data processing task and executes the data processing task according to the execution trigger operation to obtain execution result data of the data processing task so that in a task editing process, convenient viewing of a data processing result is supported to facilitate flexible adjustment of the data processing task, thereby enabling the data processing task to match data processing requirements. According to the technical solution of the embodiments of the present disclosure, visual editing of the data processing task may be realized through simple interactive operations, and data processing resources at multiple ends may be combined to enrich the editing effect of the data processing task, reduce the editing difficulty of the data processing task, broaden the application range of data editing, and improve the editing efficiency of the data processing task.

On the basis of any optional technical solution in the embodiments of the present disclosure, optionally, the task execution module 530 includes a relationship determination unit, an execution order determination unit, and a task execution unit. The relationship determination unit is configured to determine a dependency and a reverse dependency between a plurality of graphical nodes in the data processing task; the execution order determination unit is configured to determine an execution order of the graphical nodes according to the dependency and the reverse dependency; and the task execution unit is configured to execute data processing operations corresponding to the graphical nodes according to the execution order of the graphical nodes to obtain the execution result data of the data processing task.

On the basis of any optional technical solution in the embodiments of the present disclosure, optionally, the execution order determination unit is configured to establish a dependency table according to the dependency corresponding to the plurality of graphical nodes; and establish a reverse dependency table according to the reverse dependency corresponding to the plurality of graphical nodes; determine a graphical node in the dependency table in which the dependency does not exist as a first node and execute a data processing operation corresponding to the first node; and in response to an event that the data processing operation corresponding to the first node is completed, delete the first node from the dependency table and determine, from the plurality of graphical nodes, a second node that depends on the first node according to the reverse dependency table; and re-determine the first node from the second node according to the dependency table in which the first node is deleted and return to executing the operation of executing the data processing operation corresponding to the first node.

On the basis of any optional technical solution in the embodiments of the present disclosure, optionally, the data processing task includes a sub-processing task, the sub-processing task includes a graphical node that needs to be cyclically executed in the data processing task, and the graphical nodes in the data processing task include a subtask entry node and a subtask exit node that are connected to the sub-processing task; the subtask entry node is used to convert a plurality of data that need to be processed by the sub-processing task into input data in a first preset format; and the subtask exit node is used to combine a plurality of data output by the sub-processing task into output data in a second preset format.

On the basis of any optional technical solution in the embodiments of the present disclosure, optionally, the data processing task includes at least one execution link task, and the execution link task is determined according to the graphical node that is a task input node in the data processing task; and the data processing apparatus further includes a task cancel module. The task cancel module is configured to, after receiving the execution trigger operation for the data processing task, in response to a task cancel request for the execution link task, determine a plurality of graphical nodes corresponding to the execution link task and send a cancel instruction to the plurality of graphical nodes corresponding to the execution link task to cause the graphical node to stop executing the data processing operation corresponding to the graphical node.

On the basis of any optional technical solution in the embodiments of the present disclosure, optionally, the data processing apparatus further includes a tree structure construction module. The tree structure construction module is configured to, before determining the plurality of graphical nodes corresponding to the execution link task, determine a task input node among the plurality of graphical nodes in the data processing task, and for each task input node, use the task input node as a root node, construct a tree structure corresponding to the task input node according to the connection relationship between the plurality of graphical nodes in the data processing task; and the task cancel module is configured to determine a task input node corresponding to the execution link task and determine the plurality of graphical nodes in the tree structure corresponding to the task input node as the plurality of graphical nodes corresponding to the execution link task.

On the basis of any optional technical solution in the embodiments of the present disclosure, optionally, the task editing page displays a task creation identifier, the node editing operation includes at least a node addition operation, and the task determination module 520 is configured to receive, through the task editing page, a first trigger operation for the task creation identifier, and display a task editing area; and receive, through the task editing area, a node addition operation for at least one graphical node, and determine a data processing task according to the added graphical node.

On the basis of any optional technical solution in the embodiments of the present disclosure, optionally, the task editing page displays a task access identifier of a created data processing task, and the task determination module 520 is configured to receive, through the task editing page, a second trigger operation for at least one task access identifier, and display a triggered data processing task according to the second trigger operation, where the data processing task includes a plurality of graphical nodes and at least two of the plurality of graphical nodes have a connection relationship between each other; and receive a node editing operation for at least one graphical node in the data processing task and update the data processing task according to the node editing operation.

On the basis of any optional technical solution in the embodiments of the present disclosure, optionally, the execution result data of the data processing task includes media data, the graphical nodes in the data processing task include a data rendering node, the data rendering node is used to set a data rendering template and template input data of the data rendering template, and the data rendering template is used to render the template input data as media data with an expected presentation effect.

On the basis of any optional technical solution in the embodiments of the present disclosure, optionally, the execution result data of the data processing task includes program data, the graphical nodes in the data processing task include a string processing node, and the string processing node is used to adjust input program data and/or request the second end to generate program data according to node input data of the string processing node.

The data processing apparatus provided by the embodiments of the present disclosure may perform the data processing method provided by any embodiment of the present disclosure and has corresponding functional modules and beneficial effects for performing the data processing method.

It is worth noting that the units and modules included in the foregoing apparatus are only divided according to functional logic but are not limited to the foregoing division, as long as the corresponding functions may be implemented. Furthermore, the specific names of the functional units are only used to distinguish between each other but not to limit the scope of protection of the embodiments of the present disclosure.

Reference is made to FIG. 9 below, which illustrates a schematic diagram illustrating the structure of an electronic device (such as a terminal device or a server) 900 suitable for implementing the embodiments of the present disclosure. The terminal device in the embodiments of the present disclosure may include, but is not limited to, mobile terminals such as a mobile phone, a notebook computer, a digital broadcast receiver, a personal digital assistant (PDA), a tablet computer, a portable media player (PMP), and a vehicle-mounted terminal (such as a vehicle navigation terminal), and fixed terminals such as a digital TV and a desktop computer. The electronic device illustrated in FIG. 9 is merely an example and should not impose any limitation on the function and scope of use of the embodiments of the present disclosure.

As illustrated in FIG. 9, the electronic device 900 may include a processing apparatus (such as a central processing unit and a graphics processing unit) 901, which may perform various appropriate actions and processing according to a program stored in a read-only memory (ROM) 902 or a program loaded from a storage apparatus 908 into a random-access memory (RAM) 903. The RAM 903 further stores various programs and data required for the operation of the electronic device 900. The processing apparatus 901, the ROM 902, and the RAM 903 are connected to each other through a bus 904. An input/output (I/O) interface 905 is also connected to the bus 904.

Usually, the following apparatuses may be connected to the I/O interface 905: an input apparatus 906 including, for example, a touch screen, a touchpad, a keyboard, a mouse, a camera, a microphone, an accelerometer, and a gyroscope; an output apparatus 907 including, for example, a liquid crystal display (LCD), a speaker, and a vibrator; a storage apparatus 908 including, for example, a magnetic tape and a hard disk; and a communication apparatus 909. The communication apparatus 909 may allow the electronic device 900 to communicate wirelessly or via a wired connection with other devices to exchange data. Although FIG. 9 illustrates the electronic device 900 having various apparatuses, it should be understood that it is not required to implement or provide all the illustrated apparatuses. Alternatively, more or fewer apparatuses may be implemented or provided.

In particular, according to an embodiment of the present disclosure, the process described above with reference to the flowchart may be implemented as a computer software program. For example, an embodiment of the present disclosure includes a computer program product, which includes a computer program carried by a non-transitory computer-readable medium, where the computer program includes program code for performing the method illustrated in the flowchart. In such an embodiment, the computer program may be downloaded from a network and installed through the communication apparatus 909, or installed from the storage apparatus 908, or installed from the ROM 902. When the computer program is executed by the processing apparatus 901, the foregoing functions defined in the method of the embodiments of the present disclosure are executed.

The names of messages or information exchanged between a plurality of apparatuses in the implementations of the present disclosure are only for illustrative purposes and are not intended to limit the scope of these messages or information.

The electronic device provided by the embodiments of the present disclosure belongs to the same inventive concept as the data processing method provided by the foregoing embodiments. For technical details not described in detail in the embodiments of the present disclosure, reference may be made to the foregoing embodiments, and this embodiment has the same beneficial effects as the foregoing embodiments.

An embodiment of the present disclosure provides a computer storage medium having a computer program stored thereon, where the program, when executed by a processor, implements the data processing method provided by the foregoing embodiments.

It should be noted that the foregoing computer-readable medium in the present disclosure may be a computer-readable signal medium, a computer-readable storage medium, or any combination thereof. The computer-readable storage medium may be, for example, but is not limited to, an electronic, magnetic, optical, electromagnetic, infrared, or semiconductor system, apparatus, or device, or any suitable combination thereof. More specific examples of the computer-readable storage medium may include, but are not limited to, an electrically connected portable computer magnetic disk having one or more wires, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, which may be used by or used in conjunction with an instruction execution system, apparatus, or device. In the present disclosure, the computer-readable signal medium may include a data signal propagated on a baseband or as part of a carrier wave, and computer-readable program code is carried therein. The data signal propagated in this way may be in a plurality of forms and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit a program used by or in conjunction with an instruction execution system, apparatus, or device. The program code contained on the computer-readable medium may be transmitted in any suitable medium, including but not limited to a wire, an optical cable, a radio frequency (RF), or any suitable combination thereof.

According to one or more embodiments of the present disclosure, [Example 1] provides a data processing method. The method includes:
displaying a task editing page in a browser of a first end in response to a task editing request; receiving, through the task editing page, a node editing operation for at least one graphical node, and obtaining a data processing task according to the node editing operation, where at least part of data processing operations in data processing logic corresponding to the graphical node are executed at a second end; and receiving an execution trigger operation for the data processing task and executing the data processing task according to the execution trigger operation to obtain execution result data of the data processing task.

According to one or more embodiments of the present disclosure, [Example 2] provides the method of Example 1. The method further includes the following. Optionally, executing the data processing task to obtain the execution result data of the data processing task includes: obtaining a dependency and a reverse dependency between a plurality of graphical nodes in the data processing task and obtaining an execution order of the graphical nodes according to the dependency and the reverse dependency; and executing data processing operations corresponding to the graphical nodes according to the execution order of the graphical nodes to obtain the execution result data of the data processing task.

According to one or more embodiments of the present disclosure, [Example 3] provides the method of Example 1. The method further includes the following. Optionally, obtaining the execution order of the graphical nodes according to the dependency and the reverse dependency includes: establishing a dependency table according to the dependency corresponding to the plurality of graphical nodes; and establishing a reverse dependency table according to the reverse dependency corresponding to the plurality of graphical nodes; obtaining a graphical node that has no dependency in the dependency table as a first node and executing a data processing operation corresponding to the first node; and in response to an event that the data processing operation corresponding to the first node is completed, deleting the first node from the dependency table and obtaining, from the plurality of graphical nodes, a second node that depends on the first node according to the reverse dependency table; and obtaining the first node from the second node according to the dependency table in which the first node is deleted and returning to executing the operation of executing the data processing operation corresponding to the first node.

According to one or more embodiments of the present disclosure, [Example 4] provides the method of Example 1. The method further includes the following. Optionally, the data processing task includes a sub-processing task, the sub-processing task includes a graphical node that needs to be cyclically executed in the data processing task, and the graphical nodes in the data processing task include a subtask entry node and a subtask exit node that are connected to the sub-processing task; the subtask entry node is used to convert a plurality of data that need to be processed by the sub-processing task into input data in a first preset format; and the subtask exit node is used to combine a plurality of data output by the sub-processing task into output data in a second preset format.

According to one or more embodiments of the present disclosure, [Example 5] provides the method of Example 1. The method further includes the following. Optionally, the data processing task includes at least one execution link task, and the execution link task is obtained according to the graphical node that is a task input node in the data processing task; and after receiving the execution trigger operation for the data processing task, the method further includes: in response to a task cancel request for the execution link task, obtaining a plurality of graphical nodes corresponding to the execution link task and sending a cancel instruction to the plurality of graphical nodes corresponding to the execution link task to cause the graphical node to stop executing the data processing operation corresponding to the graphical node.

According to one or more embodiments of the present disclosure, [Example 6] provides the method of Example 1. The method further includes the following. Optionally, before obtaining the plurality of graphical nodes corresponding to the execution link task, the method further includes: obtaining a task input node among the plurality of graphical nodes in the data processing task, and for each task input node, using the task input node as a root node, constructing a tree structure corresponding to the task input node according to the connection relationship between the plurality of graphical nodes in the data processing task; and obtaining the plurality of graphical nodes corresponding to the execution link task includes: obtaining a task input node corresponding to the execution link task and obtaining the plurality of graphical nodes in the tree structure corresponding to the task input node as the plurality of graphical nodes corresponding to the execution link task.

According to one or more embodiments of the present disclosure, [Example 7] provides the method of Example 1. The method further includes the following. Optionally, the task editing page displays a task creation identifier, the node editing operation includes at least a node addition operation, and receiving, through the task editing page, a node editing operation for at least one graphical node, and obtaining a data processing task according to the node editing operation includes: receiving, through the task editing page, a first trigger operation for the task creation identifier, and displaying a task editing area; and receiving, through the task editing area, a node addition operation for at least one graphical node, and obtaining a data processing task according to the added graphical node.

According to one or more embodiments of the present disclosure, [Example 8] provides the method of Example 1. The method further includes the following. Optionally, the task editing page displays a task access identifier of a created data processing task, and receiving, through the task editing page, a node editing operation for at least one graphical node, and obtaining a data processing task according to the node editing operation includes: receiving, through the task editing page, a second trigger operation for at least one task access identifier ,and displaying a triggered data processing task according to the second trigger operation, where the data processing task includes a plurality of graphical nodes and at least two of the plurality of graphical nodes have a connection relationship between each other; and receiving a node editing operation for at least one graphical node in the data processing task and updating the data processing task according to the node editing operation.

According to one or more embodiments of the present disclosure, [Example 9] provides the method of Example 1. The method further includes the following. Optionally, the execution result data of the data processing task includes media data, the graphical nodes in the data processing task include a data rendering node, the data rendering node is used to set a data rendering template and template input data of the data rendering template, and the data rendering template is used to render the template input data as media data with an expected presentation effect.

According to one or more embodiments of the present disclosure, [Example 10] provides the method of Example 1. The method further includes the following. Optionally, the execution result data of the data processing task includes program data, the graphical nodes in the data processing task include a string processing node, and the string processing node is used to adjust input program data and/or request the second end to generate program data according to node input data of the string processing node.

According to one or more embodiments of the present disclosure, [Example 11] provides a data processing apparatus. The apparatus includes:
a page display module configured to display a task editing page in a browser of a first end in response to a task editing request; a task obtaining module configured to receive, through the task editing page, a node editing operation for at least one graphical node, and obtain a data processing task according to the node editing operation, where at least part of data processing operations in data processing logic corresponding to the graphical node are executed at a second end; and a task execution module configured to receive an execution trigger operation for the data processing task and execute the data processing task according to the execution trigger operation to obtain execution result data of the data processing task.

In some implementations, the client and the server may communicate using any currently known or future developed network protocol, such as the hypertext transfer protocol (HTTP), and may be interconnected with any form or medium of digital data communication (for example, a communication network). Examples of the communication network include a local area network ("LAN"), a wide area network ("WAN"), an internet (for example, the Internet), a peer-to-peer network (for example, an Ad-Hoc network), and any network currently known or to be developed in the future.

The foregoing computer-readable medium may be contained in the foregoing electronic device or may exist alone without being assembled into the electronic device.

The foregoing computer-readable medium carries one or more programs that, when executed by the electronic device, cause the electronic device to: display a task editing page in a browser of a first end in response to a task editing request; receive, through the task editing page, a node editing operation for at least one graphical node, and obtain a data processing task according to the node editing operation, where at least part of data processing operations in data processing logic corresponding to the graphical node are executed at a second end; and receive an execution trigger operation for the data processing task and execute the data processing task according to the execution trigger operation to obtain execution result data of the data processing task.

The computer program code for performing the operations of the present disclosure may be written in one or more programming languages or a combination thereof. The foregoing programming languages include object-oriented programming languages such as Java, Smalltalk, and C++, and further include conventional procedural programming languages such as "C" language or similar programming languages. The program code may be executed entirely on a user computer, partly on a user computer, as a stand-alone software package, partly on a user computer and partly on a remote computer, or entirely on a remote computer or server. In the case of the remote computer, the remote computer may be connected to the user computer through any kind of network, including a local area network (LAN) or a wide area network (WAN), or may be connected to an external computer (for example, connected through the Internet using an Internet service provider).

The flowcharts and block diagrams in the drawings illustrate the possibly implemented architectures, functions, and operations of the system, method, and computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented in software or hardware. The name of the unit does not constitute a limitation on the unit itself under certain circumstances. For example, the page display module may also be described as "a module that displays a task editing page in a browser of a first end in response to a task editing request".

The foregoing functions described herein may be performed at least partially by one or more hardware logic components. For example, without limitation, exemplary types of hardware logic components that may be used include a field programmable gate array (FPGA), an application specific integrated circuit (ASIC), an application specific standard product (ASSP), a system on chip (SOC), a complex programmable logical device (CPLD), and the like.

In the context of the present disclosure, a machine-readable medium may be a tangible medium that may contain or store a program for use by or in conjunction with an instruction execution system, apparatus, or device. The machine-readable medium may be a machine-readable signal medium or a machine-readable storage medium. The machine-readable medium includes, but is not limited to, an electronic, magnetic, optical, electromagnetic, infrared, or semiconductor system, apparatus, or device, or any suitable combination thereof. More specific examples of the machine-readable storage medium include an electrical connection based on one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

The above description illustrates merely preferred embodiments of the present disclosure and explanations of the applied technical principles. Those skilled in the art should understand that the scope of disclosure involved in the present disclosure is not limited to the technical solutions formed by specific combinations of the above technical features and should also cover other technical solutions formed by any combination of the above technical features or equivalent features thereof without departing from the above concept of disclosure. For example, a technical solution formed by a replacement of the above features with technical features with similar functions disclosed in the present disclosure (but not limited thereto) also falls within the scope of the present disclosure.

Furthermore, although the various operations are depicted in a particular order, this should not be construed as requiring that such operations be performed in the particular order shown or in a sequential order. Under specific circumstances, multitasking and parallel processing may be advantageous. Similarly, although the above discussion contains a number of specific implementation details, these should not be construed as limiting the scope of the present disclosure. Some features described in the context of separate embodiments may also be implemented in combination in a single embodiment. In contrast, various features described in the context of a single embodiment may also be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms for implementing the claims.

I/We claim:

1. A data processing method, comprising:
displaying a task editing page in a browser of a first end in response to a task editing request;
receiving, through the task editing page, a node editing operation for at least one graphical node, and obtaining a data processing task according to the node editing operation, wherein at least part of data processing operations in data processing logic corresponding to the graphical node are executed at a second end; and
receiving an execution trigger operation for the data processing task, and executing the data processing task according to the execution trigger operation to obtain execution result data of the data processing task.

2. The data processing method of claim 1, wherein executing the data processing task to obtain the execution result data of the data processing task comprises:
obtaining a dependency and a reverse dependency between a plurality of graphical nodes in the data processing task, and obtaining an execution order of the graphical nodes according to the dependency and the reverse dependency; and
executing data processing operations corresponding to the graphical nodes according to the execution order of the graphical nodes to obtain the execution result data of the data processing task.

3. The data processing method of claim 2, wherein obtaining the execution order of the graphical nodes according to the dependency and the reverse dependency comprises:
obtaining a dependency table according to the dependency corresponding to the plurality of graphical nodes, and establishing a reverse dependency table according to the reverse dependency corresponding to the plurality of graphical nodes;
obtaining the graphical node that has no dependency in the dependency table as a first node, and executing a data processing operation corresponding to the first node;
in response to an event that the data processing operation corresponding to the first node is completed, deleting the first node from the dependency table, and obtaining, from the plurality of graphical nodes, a second node that depends on the first node according to the reverse dependency table; and
obtaining the first node from the second node according to the dependency table in which the first node is deleted, and returning to executing the operation of executing the data processing operation corresponding to the first node.

4. The data processing method of claim 1, wherein the data processing task comprises a sub-processing task, the sub-processing task comprises the graphical nodes that need to be cyclically executed in the data processing task, and the graphical nodes in the data processing task comprise a subtask entry node and a subtask exit node connected to the sub-processing task; the subtask entry node being used to convert a plurality of data to be processed by the sub-processing task into input data in a first preset format, and the subtask exit node being used to combine a plurality of data output by the sub-processing task into output data in a second preset format.

5. The data processing method of claim 1, wherein the data processing task comprises at least one execution link task, the execution link task is obtained according to the graphical node that is a task input node in the data processing task, and after receiving the execution trigger operation for the data processing task, the method further comprises:
in response to a task cancel request for the execution link task, obtaining a plurality of graphical nodes corresponding to the execution link task, and sending a cancel instruction to the plurality of graphical nodes corresponding to the execution link task to cause the graphical node to stop executing the data processing operation corresponding to the graphical node.

6. The data processing method of claim 5, wherein before obtaining the plurality of graphical nodes corresponding to the execution link task, the method further comprises:
obtaining task input nodes among the plurality of graphical nodes in the data processing task, and for each of the task input nodes, using the task input node as a root node, constructing a tree structure corresponding to the task input node according to connection relationships between the plurality of graphical nodes in the data processing task; and
obtaining the plurality of graphical nodes corresponding to the execution link task comprising:
obtaining a task input node corresponding to the execution link task, and obtaining the plurality of graphical nodes in the tree structure corresponding to the task input node as the plurality of graphical nodes corresponding to the execution link task.

7. The data processing method of claim 1, wherein a task creation identifier is displayed on the task editing page, the node editing operation at least comprises a node addition operation, and receiving the node editing operation for the at least one graphical node through the task editing page and obtaining the data processing task according to the node editing operation comprises:
receiving, through the task editing page, a first trigger operation for the task creation identifier, and displaying a task editing area; and
receiving, through the task editing page, the node addition operation for the at least one graphical node, and obtaining the data processing task according to the added graphical node.

8. The data processing method of claim 1, wherein a task access identifier of a created data processing task is displayed on the task editing page, and receiving the node editing operation for the at least one graphical node through the task editing page and obtaining the data processing task according to the node editing operation comprises:
receiving, through the task editing page, a second trigger operation for the at least one task access identifier, and displaying, according to the second trigger operation, the triggered data processing task, wherein the data processing task comprises a plurality of graphical nodes and at least two of the plurality of graphical nodes have a connection relationship between each other; and
receiving a node editing operation for the at least one graphical node in the data processing task, and updating the data processing task according to the node editing operation.

9. The data processing method of claim 1, wherein the execution result data of the data processing task comprises media data, the graphical nodes in the data processing task comprise a data rendering node, the data rendering node is used to set a data rendering template and template input data of the data rendering template, and the data rendering template is used to render the template input data as media data with an expected presentation effect.

10. The data processing method of claim 1, wherein the execution result data of the data processing task comprises program data, the graphical nodes in the data processing task comprise a string processing node, and the string processing node is used to adjust input program data and/or request the second end to generate program data according to node input data of the string processing node.

11. An electronic device, comprises:
one or more processors; and
a storage configured to store one or more programs,
wherein the one or more programs, when executed by the one or more processors, cause the one or more processors to:
display a task editing page in a browser of a first end in response to a task editing request;
receive, through the task editing page, a node editing operation for at least one graphical node, and obtain a data processing task according to the node editing operation, wherein at least part of data processing operations in data processing logic corresponding to the graphical node are executed at a second end; and
receive an execution trigger operation for the data processing task, and execute the data processing task according to the execution trigger operation to obtain execution result data of the data processing task.

12. The electronic device of claim 11, wherein the one or more programs causing the one or more processors to execute the data processing task to obtain the execution result data of the data processing task further cause the one or more processors to:
obtain a dependency and a reverse dependency between a plurality of graphical nodes in the data processing task, and obtain an execution order of the graphical nodes according to the dependency and the reverse dependency; and
execute data processing operations corresponding to the graphical nodes according to the execution order of the graphical nodes to obtain the execution result data of the data processing task.

13. The electronic device of claim 12, wherein the one or more programs causing the one or more processors to execute the data processing task to obtain the execution order of the graphical nodes according to the dependency and the reverse dependency further cause the one or more processors to:
establish a dependency table according to the dependency corresponding to the plurality of graphical nodes, and establish a reverse dependency table according to the reverse dependency corresponding to the plurality of graphical nodes;
obtain the graphical node that has no dependency in the dependency table as a first node, and execute a data processing operation corresponding to the first node;
in response to an event that the data processing operation corresponding to the first node is completed, delete the first node from the dependency table, and obtain, from the plurality of graphical nodes, a second node that depends on the first node according to the reverse dependency table; and
obtain the first node from the second node according to the dependency table in which the first node is deleted, and return to executing the operation of executing the data processing operation corresponding to the first node.

14. The electronic device of claim 11, wherein the data processing task comprises a sub-processing task, the sub-processing task comprises the graphical nodes that need to be cyclically executed in the data processing task, and the graphical nodes in the data processing task comprise a subtask entry node and a subtask exit node connected to the sub-processing task; the subtask entry node being used to convert a plurality of data to be processed by the sub-processing task into input data in a first preset format, and the subtask exit node being used to combine a plurality of data output by the sub-processing task into output data in a second preset format.

15. The electronic device of claim 11, wherein the data processing task comprises at least one execution link task, the execution link task is obtained according to the graphical node that is a task input node in the data processing task, and after the one or more programs causing the one or more processors to receive the execution trigger operation for the data processing task, the one or more programs further cause the one or more processors to:
in response to a task cancel request for the execution link task, obtain a plurality of graphical nodes corresponding to the execution link task, and send a cancel instruction to the plurality of graphical nodes corresponding to the execution link task to cause the graphical node to stop executing the data processing operation corresponding to the graphical node.

16. The electronic device of claim 15, wherein before the one or more programs causing the one or more processors to obtain the plurality of graphical nodes corresponding to the execution link task, the one or more programs further cause the one or more processors to:
obtain task input nodes among the plurality of graphical nodes in the data processing task, and for each of the task input nodes, use the task input node as a root node, construct a tree structure corresponding to the task input node according to connection relationships between the plurality of graphical nodes in the data processing task; and
the one or more programs causing the one or more processors to obtain the plurality of graphical nodes corresponding to the execution link task further cause the one or more processors to:
obtain a task input node corresponding to the execution link task, and obtain the plurality of graphical nodes in the tree structure corresponding to the task input node as the plurality of graphical nodes corresponding to the execution link task.

17. The electronic device of claim 11, wherein a task creation identifier is displayed on the task editing page, the node editing operation at least comprises a node addition operation, and the one or more programs causing the one or more processors to receive the node editing operation for the at least one graphical node through the task editing page and obtain the data processing task according to the node editing operation further cause the one or more processors to:
receive, through the task editing page, a first trigger operation for the task creation identifier, and display a task editing area; and
receive, through the task editing page, the node addition operation for the at least one graphical node, and obtain the data processing task according to the added graphical node.

18. The electronic device of claim 11, wherein a task access identifier of a created data processing task is displayed on the task editing page, and the one or more programs causing the one or more processors to receive the node editing operation for the at least one graphical node through the task editing page and obtain the data processing task according to the node editing operation further cause the one or more processors to:
receive, through the task editing page, a second trigger operation for the at least one task access identifier, and display, according to the second trigger operation, the triggered data processing task, wherein the data processing task comprises a plurality of graphical nodes and at least two of the plurality of graphical nodes have a connection relationship between each other; and
receive a node editing operation for the at least one graphical node in the data processing task, and update the data processing task according to the node editing operation.

19. The electronic device of claim 11, wherein the execution result data of the data processing task comprises media data, the graphical nodes in the data processing task comprise a data rendering node, the data rendering node is used to set a data rendering template and template input data of the data rendering template, and the data rendering template is used to render the template input data as media data with an expected presentation effect.

20. A non-transitory storage medium comprising computer-executable instructions that, when executed by a computer processor, cause the computer processor to:
display a task editing page in a browser of a first end in response to a task editing request;
receive, through the task editing page, a node editing operation for at least one graphical node, and obtain a data processing task according to the node editing operation, wherein at least part of data processing operations in data processing logic corresponding to the graphical node are executed at a second end; and
receive an execution trigger operation for the data processing task, and execute the data processing task according to the execution trigger operation to obtain execution result data of the data processing task.
